(19) United States
(12) Patent Application Publication
(10) Pub. No.: US 2025/0018302 A1
(43) Pub. Date: Jan. 16, 2025

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Sangsuk Shin, Tokyo (JP); Kenta Ashizawa, Tokyo (JP); Kento Omichi, Tokyo (JP); Songaph Hang, Tokyo (JP); Yuji Obata, Tokyo (JP)

(73) Assignee: CYGAMES, INC., Tokyo (JP)

(21) Appl. No.: 18/898,005

(22) Filed: Sep. 26, 2024

Related U.S. Application Data
(63) Continuation of application No. PCT/JP2023/011427, filed on Mar. 23, 2023.

(30) Foreign Application Priority Data
Mar. 30, 2022 (JP) 2022-057317

(51) Int. Cl. A63F 13/69; A63F 13/49; A63F 13/795; A63F 13/798

(52) U.S. Cl. CPC A63F 13/69; A63F 13/49; A63F 13/798; A63F 13/795

(57) ABSTRACT

A non-transitory computer readable medium stores a program causing a computer to execute: processing for executing a first game including a first battle game against other players by using a game medium; processing for making the adjustment of the game medium executable in the first game; processing for saving, in the case in which an ending condition for the first game is met, the game medium used in the first game as a usable game medium; and processing for executing a second game including a second battle game against a computer-controlled battle opponent by using the usable game medium.

### CROSS REFERENCE TO RELATED APPLICATIONS

This application is a continuation application of International Application No. PCT/JP2023/011427, filed on Mar. 23, 2023, which claims priority to Japanese Patent Application No. 2022-057317, filed on Mar. 30, 2022, the entire contents of which are incorporated by reference herein.

### BACKGROUND ART

### Technical Field

The present invention relates to an information processing program, an information processing method, and an information processing system.

In the related art, for example, as indicated in Patent Literature 1, there is a known game genre of so-called simulation game. In addition, for example, as indicated in Non-Patent Literature 1, there is a known new game genre referred to as auto battler. In games classified in these game genres, players battle one another by employing owned game media (so-called “game pieces”) of the respective players.

### CITATION LIST

### Patent Literature

Patent Literature 1: JP 6235669 B

### Non-Patent Literature

Non-Patent Literature 1: What is the game genre “auto battler” representing 2019? (http://www.e-xtreme.co.jp/topics/4626/)

### SUMMARY OF INVENTION

### Technical Problem

Regarding a game in Patent Literature 1 or Non-Patent Literature 1, there is a demand for enhancing the motivation of a player to repeatedly play the game.

An object of the present invention is to provide an information processing program, an information processing method and an information processing system with which it is possible to enhance the play motivation of a player.

### Solution to Problem

In order to solve the above-described problem, provided is an information processing program that causes a computer to execute: processing for executing a first game including a first battle game against other players by using a game medium; processing for making the adjustment of the game medium executable in the first game; processing for saving, in the case in which an ending condition for the first game is met, the game medium used in the first game as a usable game medium; and processing for executing a second game including a second battle game against a computer-controlled battle opponent by using the usable game medium.

The information processing program may further cause the computer to execute processing for determining ranking of a player on the basis of a result of the first battle game, wherein the processing for making the adjustment of the game medium executable is executable between the start and the end of the first battle game.

With the information processing program, the usable game medium may be usable only once.

With the information processing program, the processing for making the adjustment of the game medium executable may make it possible to perform at least one of changing the game medium to be used and changing a parameter of the game medium on the basis of an operation by the player.

In order to solve the above-described problem, provided is an information processing method executed by at least one computer, wherein the computer executes: processing for executing a first game including a first battle game against other players by using a game medium; processing for making the adjustment of the game medium executable in the first game; processing for saving, in the case in which an ending condition for the first game is met, the game medium used in the first game as a usable game medium; and processing for executing a second game including a second battle game against a computer-controlled battle opponent by using the usable game medium.

In order to solve the above-described problem, provided is an information processing system including at least one computer, wherein the computer executes: processing for executing a first game including a first battle game against other players by using a game medium; processing for making the adjustment of the game medium executable in the first game; processing for saving, in the case in which an ending condition for the first game is met, the game medium used in the first game as a usable game medium; and processing for executing a second game including a second battle game against a computer-controlled battle opponent by using the usable game medium.

### Effects of Disclosure

With the present invention, it is possible to enhance the player motivation of a player.

### BRIEF DESCRIPTION OF DRAWINGS

FIG. 1 is an explanatory diagram showing a schematic configuration of an information processing system.

FIG. 2A is a diagram for explaining the hardware configuration of a player terminal. FIG. 2B is a diagram for explaining the hardware configuration of a server.

FIG. 3A is a diagram for explaining a mini-game selection screen. FIG. 3B is a diagram for explaining an auto-battler game selection screen.

FIG. 4 is a diagram for explaining a rough flow of proceeding of a normal battle.

FIG. 5 is a diagram for explaining an example of a matching screen.

FIG. 6 is a diagram for explaining an example of a unit setting table.

FIG. 7A is a diagram for explaining a power-up guild lottery screen. FIG. 7B is a diagram for explaining a power-up-guild-lottery completion screen. FIG. 7C is a diagram for explaining a start unit screen.

FIG. 8A is a first diagram for explaining a purchase pop-up. FIG. 8B is a diagram for explaining a purchase guide pop-up. FIG. 8C is a second diagram for explaining the purchase pop-up.

FIG. 9A is a first diagram for explaining a preparation screen. FIG. 9B is a second diagram for explaining the preparation screen. FIG. 9C is a diagram for explaining a battle screen.

FIG. 10A is a diagram showing an example of a round result of a normal battle. FIG. 10B is a diagram for explaining a result screen of the normal battle.

FIG. 11 is a diagram for explaining a rough flow of proceeding of a boss challenge.

FIG. 12A is a first diagram for explaining a deck selection screen. FIG. 12B is a diagram for explaining a used deck screen. FIG. 12C is a second diagram for explaining the deck selection screen.

FIG. 13A is a diagram for explaining a use confirmation screen. FIG. 13B is a diagram for explaining a battle screen of a boss challenge. FIG. 13C is a diagram for explaining a result display of the boss challenge.

FIG. 14A is a first diagram for explaining a result screen of the boss challenge. FIG. 14B is a second diagram for explaining the result screen of the boss challenge. FIG. 14C is a diagram for explaining an ending screen of the boss challenge.

FIG. 15 is a diagram for explaining the configuration of a memory in the player terminal and the function thereof as a computer.

FIG. 16 is a diagram for explaining the configuration of a memory in the server and the function thereof as a computer.

FIG. 17 is a sequence diagram for the player terminal and the server.

FIG. 18 is a first flowchart for explaining an example of terminal-side normal-battle management processing in the player terminal.

FIG. 19 is a second flowchart for explaining the example of the terminal-side normal-battle management processing in the player terminal.

FIG. 20 is a third flowchart for explaining the example of the terminal-side normal-battle management processing in the player terminal.

FIG. 21 is a first flowchart for explaining an example of server-side normal-battle management processing in the server.

FIG. 22 is a second flowchart for explaining the example of the server-side normal-battle management processing in the server.

FIG. 23 is a first flowchart for explaining an example of terminal-side boss-challenge management processing in the player terminal.

FIG. 24 is a second flowchart for explaining the example of the terminal-side boss-challenge management processing in the player terminal.

FIG. 25 is a flowchart for explaining an example of server-side boss-challenge management processing in the server.

### DESCRIPTION OF EMBODIMENT

An aspect of an embodiment of the present invention will be described below with reference to the attached drawings. Values, etc. indicated in said embodiment are merely examples for facilitating understanding, and do not limit the present invention unless otherwise specifically mentioned. Note that, in the present description and the drawings, elements having substantially the same functions and configurations have the same reference signs attached thereto and are not described repeatedly, and, in addition, elements that are not directly relevant to the present invention are not shown.

(Overall configuration of information processing system S)

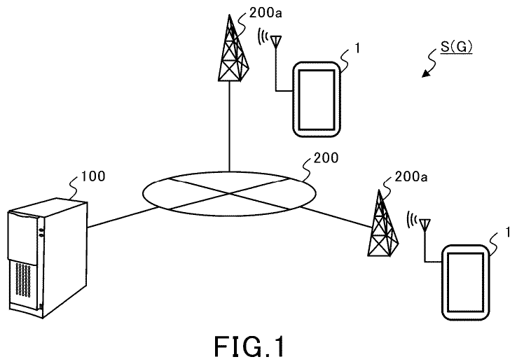

FIG. 1 is an explanatory diagram showing, in outline, the configuration of an information processing system S. The information processing system S is a so-called client server system including: player terminals 1 that serve as clients, in other words, game terminals; a server 100; and a communication network 200 having communication base stations 200a.

In the information processing system S of this embodiment, the player terminals 1 and the server 100 serve as a game device G. Functions in game proceeding control are respectively allocated to the player terminals 1 and the server 100 and a game can proceed as a result of cooperation between the player terminals 1 and the server 100.

The player terminals 1 can establish communication with the server 100 via the communication network 200. The player terminals 1 include a wide range of electronic appliances that are capable of communicatively connecting to the server 100 in a wireless or wired manner. Examples of the player terminals 1 include smartphones, mobile phones, tablet devices, personal computers, and game machines. This embodiment will be described in the context of a case where smartphones are used as the player terminals 1.

The server 100 is communicatively connected to the plurality of player terminals 1. The server 100 accumulates various kinds of information for each player who plays the game. In addition, the server 100 performs, on the basis of operations input from the player terminals 1, processing such as updating of the accumulated information and causing the player terminals 1 to download images and various kinds of information.

The communication base stations 200a are connected to the communication network 200 and transmit information to and receive information from the player terminals 1 in a wireless manner. The communication network 200 consists of a mobile phone network, an internet network, a local area network (LAN), a dedicated line, or the like and realizes wireless or wired communication connection between the player terminals 1 and the server 100.

(Hardware configurations of player terminal 1 and server 100)

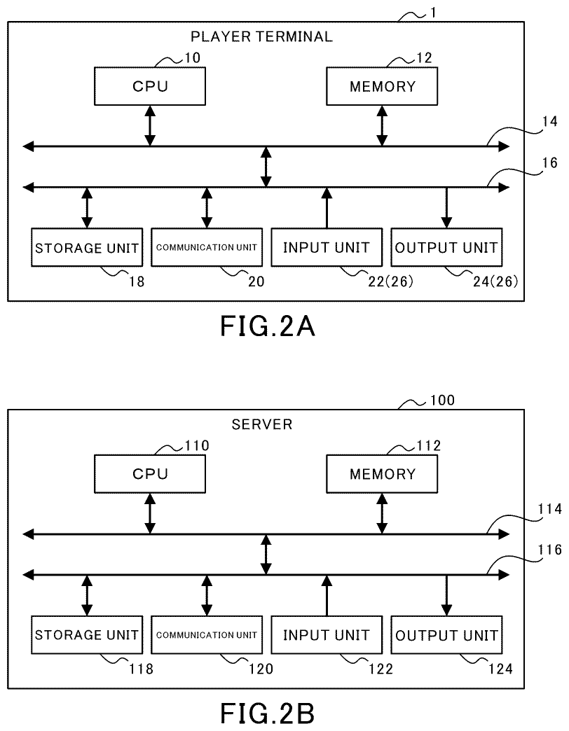

FIG. 2A is a diagram for explaining the hardware configuration of a player terminal 1. In addition, FIG. 2B is a diagram for explaining the hardware configuration of the server 100. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

In addition, as shown in FIG. 2B, the server 100 is configured to include a CPU 110, a memory 112, a bus 114, an input/output interface 116, a storage unit 118, a communication unit 120, an input unit 122, and an output unit 124.

Note that the configurations and functions of the CPU 110, the memory 112, the bus 114, the input/output interface 116, the storage unit 118, the communication unit 120, the input unit 122, and the output unit 124 of the server 100 are substantially the same as those of the CPU 10, the memory 12, the bus 14, the input/output interface 16, the storage unit 18, the communication unit 20, the input unit 22, and the output unit 24 of the player terminal 1, respectively. Therefore, the following description will be directed to the hardware configuration of the player terminal 1, while omitting a description of the server 100.

The CPU 10 runs a program stored in the memory 12 to control the proceeding of the game. The memory 12 is configured of a read only memory (ROM) or a random access memory (RAM) and stores the program and various kinds of data needed to control the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is communicatively connected to a communication base station 200a in a wireless manner and transmits information to and receives information from the server 100, such as various kinds of data and programs, via the communication network 200. In the player terminal 1, programs, etc. received from the server 100 are stored in the memory 12 or the storage unit 18.

The input unit 22 is configured of a unit via which player operations are input (operations are accepted), for example, a touchscreen, buttons, a keyboard, a mouse, a cross keypad, an analog controller, or the like. In addition, the input unit 22 may be a dedicated controller that is provided in the player terminal 1 or connected (externally) to the player terminal 1. Furthermore, the input unit 22 may be configured of an acceleration sensor that detects tilting or movement of the player terminal 1 or a microphone that detects the player's voice. In other words, the input unit 22 includes a wide range of devices that enable the input of the player's intents in distinguishable manners.

The output unit 24 is configured to include a display device and a speaker. Note that the output unit 24 may be a device connected (externally) to the player terminal 1. In this embodiment, the player terminal 1 includes a display 26 as the output unit 24 and a touchscreen as the input unit 22, the touchscreen being provided so as to be overlaid on the display 26.

(Game specifics)

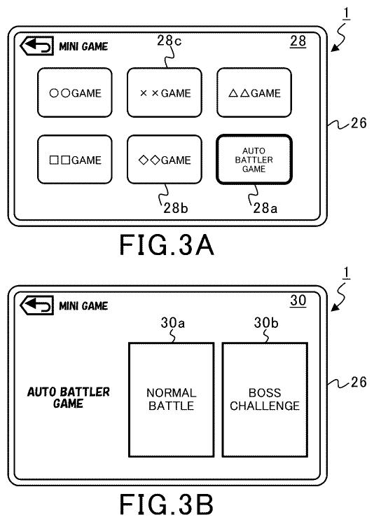

Next, mini games provided by means of the information processing system S and the game device G of this embodiment will be described. Before starting the mini games, a player downloads a dedicated application to the player terminal 1 in advance from the server 100 and registers a player ID in the server 100. When the application is started up, the player terminal 1 receives various kinds of information stored in the server 100 and displays various screens on the display 26. FIG. 3A is a diagram for explaining a mini-game selection screen 28. As shown in FIG. 3A, on the mini-game selection screen 28, a plurality of mini-game selection operation portions 28a, 28b, and 28c that the player can select are displayed.

In each of the mini-game selection operation portions 28a, 28b, and 28c, an image indicating the title of a mini game that a player can select is displayed. In this embodiment, when the player operates (taps) the mini-game selection operation portion 28a, a so-called auto battler, a game in which the player engages in a battle by employing owned game media (so-called “game pieces”) of the player, becomes executable as one of the mini games.

In this embodiment, as the auto battler games, a normal battle (first game) and a boss challenge (second game) are executable. Although details will be described later, the normal battle (first game) mainly provides a game in which a plurality of players mainly repeatedly engage in a one-on-one round battle (first battle game) with each other and ranking among the plurality of players is determined. In addition, the boss challenge (second game) mainly provides a game in which a player engages in a one-on-one battle game (second battle game) against a so-called non player character (hereinafter also referred to as the NPC).

FIG. 3B is a diagram for explaining an auto-battler game selection screen 30. When the mini-game selection operation portion 28a on the display 26 is operated (tapped), the auto-battler game selection screen 30 shown in FIG. 3B is displayed on the display 26.

As shown in FIG. 3B, the auto-battler game selection screen 30 displays a normal-battle operation portion 30a indicated as “normal battle” and a boss-challenge operation portion 30b indicated as “boss challenge”.

When the normal-battle operation portion 30a on the display 26 is operated (tapped), a normal battle is started. In addition, when the boss-challenge operation portion 30b on the display 26 is operated (tapped), a boss challenge is started.

(Normal battle)

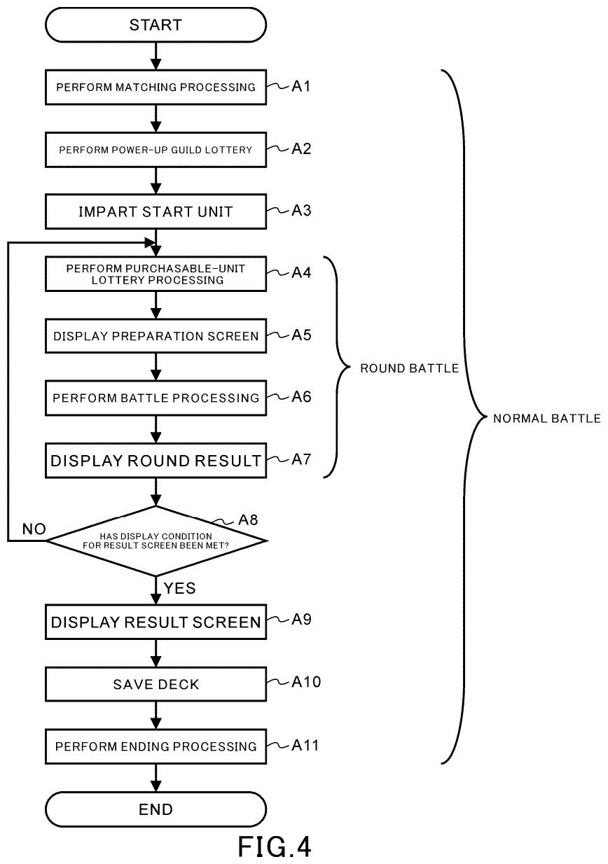

FIG. 4 is a diagram for explaining a rough flow of proceeding of a normal battle. Note that, in the following, among participants participating in the normal battle, an operating subject of a prescribed player terminal 1 will be simply referred to as a player. In addition, among the participants participating in the normal battle, battle opponents in the eyes of the player will be referred to as opponent players (other players). In addition, among the participants participating in the normal battle, all participants including the player and the opponent players will be referred to as the participating players.

In this embodiment, a normal battle in which eight participating players battle one another will be described. Specifically, the normal battle according to this embodiment is executed by means of, for example, a communication battle employing a plurality of player terminals 1. However, the number of participating players to participate in the normal battle may be less than eight or equal to or more than nine.

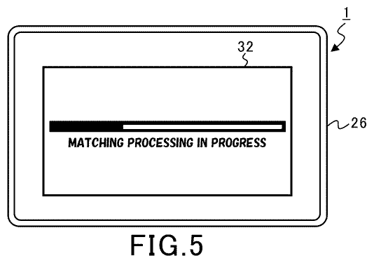

FIG. 5 is a diagram for explaining an example of a matching screen 32. When the normal battle execution is started, matching processing (A1) is executed in the server 100. While the matching processing (A1) is being executed in the server 100, the matching screen 32 is displayed on the display 26. On the matching screen 32, the player is notified that the matching processing is being executed. For example, on the matching screen 32, a gauge image that suggests the amount of time remaining until the end of the matching processing is displayed.

In the matching processing (A1), matching of the eight participating players participating in the normal battle is performed. Note that, in the case in which it was not possible to complete the matching of the eight participating players within a prescribed amount of matching time set in advance, at least some of the participating players may be replaced with NPCs. In this case, the normal battle is executed with, for example, seven participating players and one NPC.

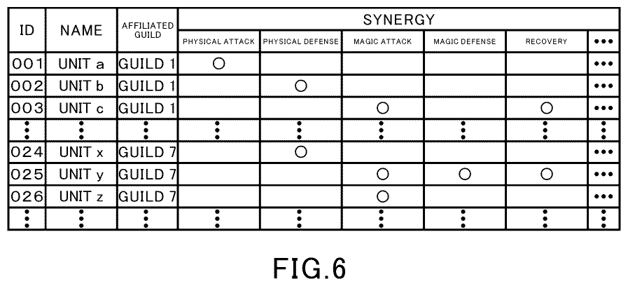

FIG. 6 is a diagram for explaining an example of a unit setting table. In this embodiment, of a plurality of types of units (game media), the player can use (select) desired units from among units that satisfy prescribed owning conditions (which will also be referred to as the “owned units” in the following) to organize a “deck”. The “deck” is a term that indicates a collection of the units formed by combining at least one owned unit. Then, the round battle against the opponent players is executed by employing (using) the organized “deck”.

As shown in FIG. 6, regarding the respective units, an ID, a name, and an affiliated guild allocated to each unit are set in advance. The affiliated guild indicates a group to which at least one unit belongs.

In addition, regarding the respective units, prescribed parameters and prescribed skills are set in advance. For example, as the prescribed parameters, the “HP (physical strength value) ”, the “physical attack power”, the “physical defense power”, the “magic attack power”, the “magic defense power”, etc. are set. For example, it is specified that the amount of damage inflicted on an enemy due to a physical attack increases as the value of the “physical attack power” parameter increases. In addition, it is specified that the amount of damage inflicted by the enemy due to a physical attack decreases as the value of the “physical defense power” parameter increases. It is specified that the amount of damage inflicted on the enemy due to a magic attack increases as the value of the “magic attack power” parameter increases. In addition, it is specified that the amount of damage inflicted by the enemy due to a magic attack decreases as the value of the “magic defense power” parameter increases.

In addition, as the prescribed skills, a “recovery skill”, a “buff skill”, a “debuff skill”, etc. are set. The skills are techniques (abilities) that are associated with the respective units and that are activated by the units during a game. The activation of skills causes changes in various parameters of the player's units and/or other units. For example, the “recovery skill” is specified to recover the “HPs (physical strength values)” of the player's units and/or other units. In addition, the “buff skill” is specified to increase one or more parameters among the “physical attack power”, the “physical defense power”, the “magic attack power”, and the “magic defense power” of the player's units or other units. In addition, the “debuff skill” is specified to decrease one or more parameters among the “physical attack power”, the “physical defense power”, the “magic attack power”, and the “magic defense power” of the player's units and/or other units.

In addition, as shown in FIG. 6, regarding the respective units, at least one synergy is set in advance. The synergies are provided in correspondence with the above-described prescribed parameters and prescribed skills. In this embodiment, by incorporating different units in which a common synergy is specified into the “deck” in a prescribed number or more, it becomes possible to increase the values of the prescribed parameters corresponding to the synergies and to enhance the abilities of the prescribed skills corresponding to the synergies.

In this embodiment, the effect of a synergy is provided in three stages. A first-stage synergy is activated by incorporating three or more different units in which a common synergy is specified into the “deck”. In addition, a second-stage synergy is activated by incorporating five or more different units in which the common synergy is specified into the “deck”. In addition, a third-stage synergy is activated by incorporating seven or more different units in which the common synergy is specified into the “deck”. Note that a synergy is specified such that the effect of the synergy increases as the stage thereof increases.

In addition, in this embodiment, the respective owned units have a plurality of evolutionary stages (three stages in this embodiment). Specifically, the owned units initially belong to a stage I of the evolutionary stages, and, by combining (synthesizing) the same type of owned units at the same stage set in advance with each other, it is possible to achieve evolution to the next stage. For example, by combining three units a belonging to the stage I, it is possible to obtain one evolved unit a belonging to a stage II. In addition, by combining three units a belonging to the stage II, it is possible to obtain one evolved unit a belonging to a stage III. It is specified that, regarding the respective owned units, the values of the prescribed parameters are increased and the abilities of the prescribed skills are enhanced, as the stage advances.

In addition, regarding the respective units, rarity is set. The rarity is provided in five stages of one star to five stars. In this embodiment, it is specified that the values of the prescribed parameters and the abilities of the prescribed skills are higher in a unit having higher rarity.

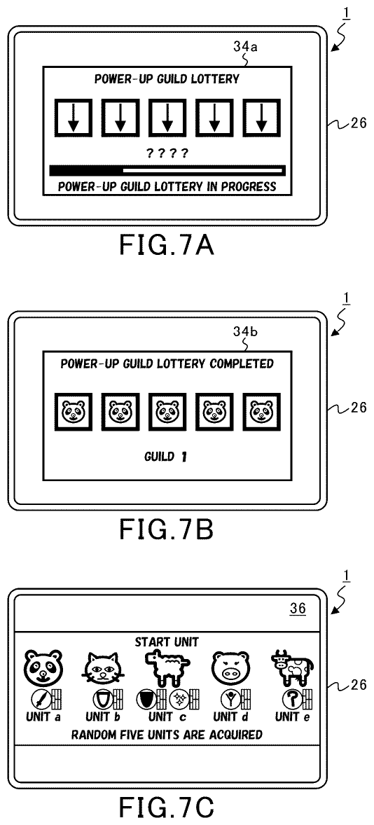

FIG. 7A is a diagram for explaining a power-up guild lottery screen 34a. FIG. 7B is a diagram for explaining a power-up-guild-lottery completion screen 34b. When the execution of the matching processing (A1) in the server 100 ends, next, a power-up guild lottery (A2) is executed in the server 100 (FIG. 4). In the power-up guild lottery, of a plurality of types of guilds, one of the guilds is determined to be a power-up guild. Also, it is specified that, regarding units belonging to the guild determined to be the power-up guild, the values of the prescribed parameters are increased and the abilities of the prescribed skills are enhanced in said normal battle.

While the power-up guild lottery (A2) is in progress, as shown in FIG. 7A, the power-up guild lottery screen 34a is displayed on the display 26. In the power-up guild lottery screen 34a, the player is notified that the power-up guild lottery is in progress. For example, in the power-up guild lottery screen 34a, a gauge image that suggests the amount of time remaining until the end of the power-up guild lottery is displayed. In addition, in the power-up guild lottery screen 34a, reels in which images indicating the units change at a high speed are displayed.

Then, when the power-up guild lottery in the server 100 ends (is completed), as shown in FIG. 7B, the power-up-guild-lottery completion screen 34b is displayed on the display 26.

In the power-up-guild-lottery completion screen 34b, the player is notified that the power-up guild lottery has ended. In addition, in the power-up-guild-lottery completion screen 34b, the type of the guild determined (selected) by the power-up guild lottery is displayed. In addition, on the power-up-guild-lottery completion screen 34b, the reels stop and images indicating one unit belonging to the guild determined (selected) by the power-up guild lottery are displayed.

Note that, in this embodiment, a case in which the guild determined to be the power-up guild is the same among the eight participating players participating in the normal game is described; however, the guild determined to be the power-up guild may be different for each of the eight participating players participating in the normal game.

In the normal battle, the player aims to create a more powerful “deck” by organizing the owned units in consideration of the respective conditions of the synergy, the evolutionary stage, the rarity, and the power-up guild.

FIG. 7C is a diagram for explaining a start unit screen 36. In the server 100, when the power-up guild lottery (A2) ends, a plurality of units (start units) to be given (distributed) to the respective participating players of the normal battle are determined (A3 in FIG. 4). The specifics (unit combination) of the start units may be the same or different for the respective participating players.

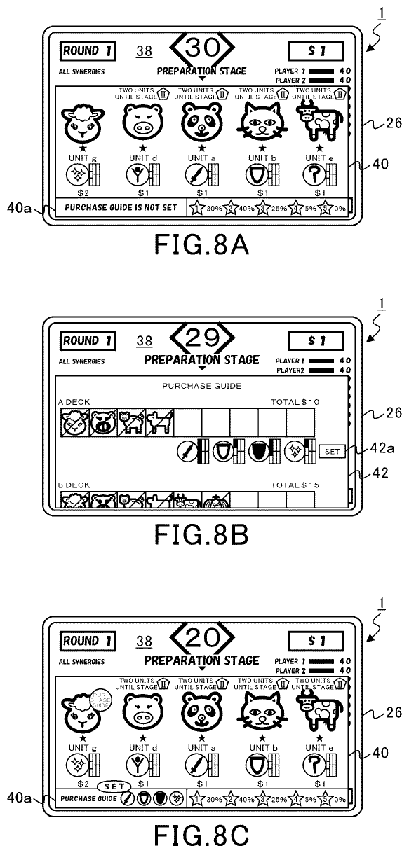

FIG. 8A is a first diagram for explaining a purchase pop-up 40. FIG. 8B is a diagram for explaining a purchase guide pop-up 42. FIG. 8C is a second diagram for explaining the purchase pop-up 40. When the start units are distributed to the respective participating players, a round battle starts. When the round battle starts, first, a purchasable-unit lottery processing (A4) is executed in the server 100 (FIG. 4). In the purchasable-unit lottery processing (A4), a plurality of units that the player can purchase by using an in-game currency (which will also be referred to as the “purchasable units” in the following) while the started round battle is being executed are determined by means of a lottery.

Note that, in this embodiment, basic rewards that are set in advance, victory rewards that are given in accordance with the win/lose result in a previous round battle, consecutive victory rewards that are given in accordance with the number of consecutive victories in the round battle, and interest rewards that are given in accordance with the amount of the in-game currency the player possesses at the end of the previous round battle are respectively determined in the server 100 at the start of each round battle and said rewards are given to the player. Note that only the basic rewards are given in the first (first round of) round battle.

In the server 100, when the purchasable units are determined by the purchasable-unit lottery processing (A4), as shown in FIG. 8A, a preparation screen 38 is displayed on the display 26 (A5 in FIG. 4). Furthermore, the purchase pop-up 40 for issuing a notification about the determined purchasable units is displayed on the display 26 so as to be superimposed on the preparation screen 38.

In the purchase pop-up 40, the units determined to be the purchasable units are displayed. In addition, in the purchase pop-up 40, the rarity, the specifics of the synergy, the number of units required to advance the evolutionary stage, and the amount of the in-game currency required for the purchase are displayed for each unit.

In addition, in a lower right section of the purchase pop-up 40, the winning probabilities in the purchasable-unit lottery processing are displayed for the units of the respective rarities. In this embodiment, the winning probabilities change so that it is more likely that the units of a higher rarity are won in the unit lottery processing as the level (rank) of the player increases while the normal battle is being executed.

In this embodiment, during a period from when the display of the preparation screen 38 is started until a prescribed amount of time (30 seconds in this case) set in advance passes, the player needs to organize the “deck” to be used in said round battle. As shown in FIG. 8A, in the center of an upper section of the preparation screen 38, a timer for clocking (counting down) the prescribed amount of time is displayed.

Meanwhile, in order to advance the normal battle in an advantageous manner, as indicated above, the player needs to organize the owned units in consideration of the respective conditions of the synergy, the evolutionary stage, the rarity, and the power-up guild. Consequently, there is a risk of a beginner player finding it difficult to organize an appropriate “deck” within the limited amount of time and losing interest in the game. Thus, in this embodiment, a “purchase guide” function is provided to assist the player to organize the “deck”.

As shown in FIG. 8A, in a lower left section of the purchase pop-up 40, a purchase guide operation portion 40a is displayed. FIG. 8A shows a case in which the “purchase guide” function is not set. In the case in which the “purchase guide” function is not set, as shown in FIG. 8A, an image indicating “purchase guide is not set” is displayed in the purchase guide operation portion 40a.

When the player operates (taps) the purchase guide operation portion 40a, as shown in FIG. 8B, the purchase guide pop-up 42 is displayed on the display 26 so as to be superimposed on the preparation screen 38.

As shown in FIG. 8B, a plurality of “decks” that serve as creation targets set in advance are displayed in the purchase guide pop-up 42. For each “deck”, a setting operation portion 42a is displayed. In addition, for each “deck”, the specifics (unit combination) of the “deck”, the amount of the in-game currency required to create said “deck”, and the specifics of the synergy in the case in which said “deck” is created are displayed (notified). In this embodiment, as the amount of the in-game currency required to create a “deck”, the amount of in-game currency required in the case in which the evolutionary stage is stage I for all of the units included in said “deck” is displayed.

Then, when the player operates (taps) the setting operation portion 42a, the specifics of the “deck” corresponding to the operated setting operation portion 42a are set to the “purchase guide” function and displayed in the purchase pop-up 40, as shown in FIG. 8C.

In the case in which the “purchase guide” function is set, as shown in FIG. 8C, of the units displayed in the purchase pop-up 40, an icon indicated as “purchase guide” is displayed for the units incorporated into the “deck” set for the “purchase guide”. Accordingly, the player can instantly ascertain the units included in the “deck” the player himself/herself has set as the creation target, in other words, the units the player should purchase. Consequently, the interests in the game can be enhanced.

The player can purchase the units displayed in the purchase pop-up 40 by using the in-game currency the player possesses and incorporate the purchased units into the owned units of the player. In addition, the game may be configured in such a way that the player can acquire the in-game currency by selling the owned units the player owns.

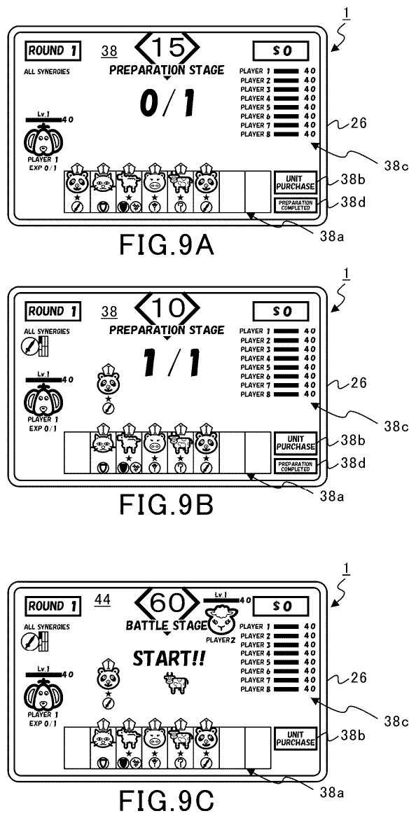

The units incorporated into the owned units are displayed in a standby display section 38a in FIG. 9A, described later. Note that the game may be configured in such a way that the units displayed in the purchase pop-up 40 can be updated by using the in-game currency the player possesses. By employing such a configuration, the player can quickly incorporate the units he/she desires into the owned units.

FIG. 9A is a first diagram for explaining the preparation screen 38. FIG. 9B is a second diagram for explaining the preparation screen 38. Note that, when a prescribed operation (tapping of a portion outside the display region of the purchase pop-up 40) is executed while the purchase pop-up 40 is displayed on the display 26, the purchase pop-up 40 is hidden and the entire preparation screen 38 becomes visible, as shown in FIG. 9A.

Similarly, when the prescribed operation (tapping of a portion outside the display region of the purchase guide pop-up 42) is executed while the purchase guide pop-up 42 is displayed on the display 26, the purchase guide pop-up 42 is hidden and the entire preparation screen 38 becomes visible, as shown in FIG. 9A.

As shown in FIG. 9A, the preparation screen 38 displays the standby display section 38a that displays, in a list, the owned units that are not incorporated into the “deck”, among the owned units of the player. As shown in FIG. 9A, in the standby display section 38a, the evolutionary stage, the rarity, and the specifics of the synergy of the owned units are displayed in a distinguishable manner.

Note that, in the standby display section 38a, eight owned units can be displayed at most. The player can organize the “deck” by operating (tapping) the owned units displayed in the standby display section 38a.

For example, in FIG. 9A, in the case in which the owned unit positioned farthest to the left side in the standby display section 38a is tapped, said tapped owned unit is incorporated into the “deck”, as shown in FIG. 9B. The owned unit incorporated into the “deck” is moved toward a center portion of the display 26 from the standby display section 38a, as shown in FIG. 9B.

In addition, in the preparation screen 38, a unit-purchase operation portion 38b is displayed. When the unit-purchase operation portion 38b is operated (tapped), the purchase pop-up 40 is displayed on the display 26.

Note that, at the very start of the normal battle, the player level (rank) is set to “1”. In this embodiment, the number of owned units that can be incorporated into the “deck” is set to be equal to the player level. Specifically, for example, if the player level is “1”, the number of the owned units that can be incorporated into the “deck” is “1”. The player level increases depending on the total value of the experience point obtained in the case in which the round battle is won. Note that the player may be allowed to purchase the experience point by using the in-game currency.

In addition, on the preparation screen 38, a physical-strength display portion 38c that displays, in a list, the remaining physical strengths of the respective participating players is displayed. In this embodiment, when the normal battle is started, a prescribed amount of physical strength is set for each of the participating players. Then, in each round battle, the physical strength decreases for players who lost the round battle.

When a player loses all of the physical strength (the physical strength reaches 0), the game is over for that player at that point in time and the ranking of the player is determined. For example, among the participating players, the ranking of the player who has lost all of the physical strength (the physical strength reaches 0) first is determined to be the lowest (8th place) and the ranking of the player who has finally remained without losing all of the physical strength is determined to be 1st place (victory). Note that provisional ranking may be notified by displaying, in real time in the physical-strength display portion 38c, the remaining physical strengths of the respective participating players in decreasing order or increasing order.

In addition, in an upper left section of the preparation screen 38, the round number of round battle that is being executed is displayed. Here, an image indicating “ROUND 1”, which indicates that the first round battle is being executed, is displayed.

In addition, in the upper left section of the preparation screen 38, an icon that notifies the specifics of the synergy based on the “deck” of the player is displayed.

In addition, in a lower left section of the preparation screen 38, the current physical strength, the current level, the amount of experience point required to reach the next level, the user name (name), and the icon image of the player are displayed.

In addition, on the preparation screen 38, a preparation complete operation portion 38d is displayed. In this embodiment, the battle game in the round battle starts in the case in which the value of a timer displayed in the center of an upper section of the preparation screen 38 reaches “0” and in the case in which the player and an opponent player both operate (tap) the preparation complete operation portion 38d before the value of the timer displayed in the center of the upper section of the preparation screen 38 reaches “0”.

FIG. 9C is a diagram for explaining a battle screen 44. When the battle game in the round battle starts, the battle screen 44 is displayed on the display 26, as shown in FIG. 9C. When the battle screen 44 is displayed, the units incorporated into the “decks” of the opponent players are displayed and the battle starts.

In the server 100, battle processing for determining win/lose in the battle game in the round battle is executed on the basis of the specifics of the “deck” of the player and the specifics of the “decks” of the opponent players (A6 in FIG. 4). On the display 26, a battle image (battle movie) showing the state of the battle is displayed (played) on the basis of the result of the battle processing in the server 100.

In this embodiment, when the battle game in the round battle starts, the player cannot change the organization of the “deck” while said battle game is being executed. Meanwhile, while the battle game is being executed, the player can perform unit purchasing operation in the purchase pop-up 40, operation related to the evolution of the owned units displayed in the standby display section 38a, and setting operation of the “purchase guide” function in the purchase guide pop-up 42.

Accordingly, the player may attentively watch the state of the battle in the battle game in the round battle or the player can perform various kinds of operations in preparation for the next round battle. Due to these features, it is possible to enhance the interests in the game.

The battle game in the round battle ends, when the HPs of all of the units incorporated into the “deck” of the player are entirely lost (0), when the HPs of all units incorporated into the “decks” of the opponent players are entirely lost (0), or when a prescribed amount of time (in this case, 60 s) has passed since the battle game has started.

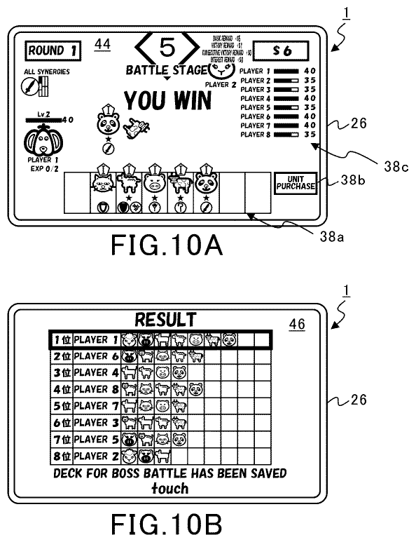

FIG. 10A is a diagram showing an example of round results in the normal battle. When the battle game ends, round results indicating the results of the battle game are displayed on the battle screen 44, as shown in FIG. 10A (A7 in FIG. 4). In the round results, win/lose of the player and the specifics of the rewards to be awarded to the player at the start of the next round battle are notified.

FIG. 10B is a diagram for explaining a result screen 46 in the normal battle. In the case in which a display condition set in advance for the result screen 46 is met on the basis of the battle game results (“YES” in A8 in FIG. 4), the result screen 46 is displayed on the display 26 (A9 in FIG. 4). In this embodiment, the case in which the display condition set in advance for the result screen 46 is met is defined as a case in which the player has lost the battle game and the physical strength of the player is entirely lost or a case in which the player achieves the first place (victory) in the ranking.

FIG. 10B shows the result screen 46 displayed in the case in which the player achieves the first place (victory) in the ranking. As shown in FIG. 10B, on the result screen 46, the ranking of the participating players and the specifics of the “decks” of the participating players are displayed in a list for the point in time at which the ranking was determined.

In addition, as shown in FIG. 10B, an image indicating “deck for boss battle has been saved” is displayed in a lower section of the display 26, and the “deck” of the player organized in the battle game in the round battle immediately before the result screen 46 is displayed is saved in the player terminal 1 and the server 100 (A10 in FIG. 4). The “deck” of the player saved here can be used in the boss challenge, described later.

In addition, as shown in FIG. 10B, an image indicating “touch” is displayed in the lower section of the display 26, and, when the player performs tapping operation thereof, prescribed ending processing (A11) is executed and the normal battle ends.

Meanwhile, in the case in which the result-screen display condition is not met when ending the round battle, in other words, in the case in which the physical strength of the player has not been entirely lost, and in the case in which the player has not achieved the first place (victory) in the ranking, the next round battle starts (“NO” in A8 in FIG. 4). Then, the processing from A4 to A7 in FIG. 4 is repeatedly executed until the result-screen display condition is met. In other words, the round battle is repeatedly executed until the ranking of the player is determined.

### (Boss Challenge)

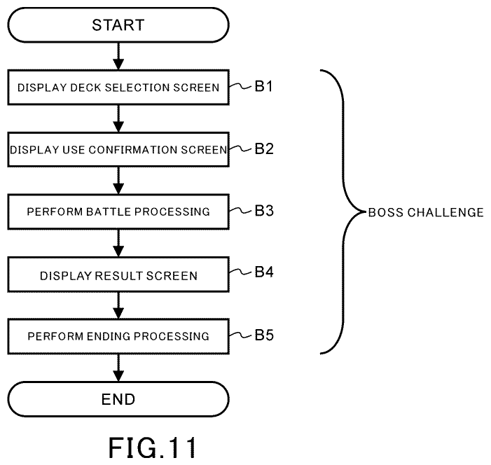

FIG. 11 is a diagram for explaining a rough flow of the proceeding of the boss challenge. As indicated above, the boss challenge mainly provides a game in which the player engages in a one-on-one battle game against an NPC. However, the boss challenge may have game properties wherein the player engages in a battle game against an NPC in cooperation with the other players.

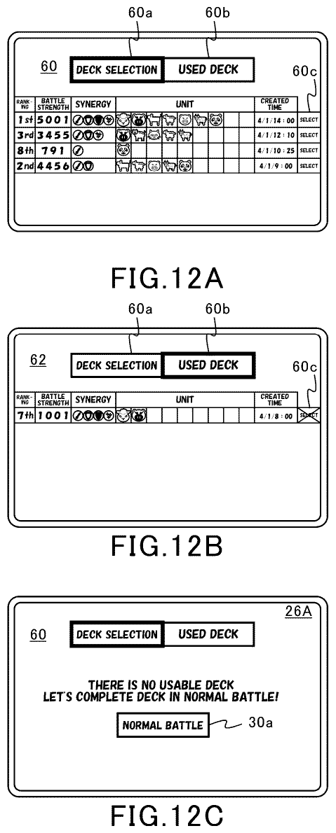

FIG. 12A is a first diagram for explaining a deck selection screen 60. FIG. 12B is a diagram for explaining a used deck screen 62. FIG. 12C is a second diagram for explaining the deck selection screen 60. When the execution of the boss challenge starts, the deck selection screen 60 shown in FIG. 12A is displayed on the display 26 (B1 in FIG. 11).

As shown in FIG. 12A, a deck-selection operation portion 60a for displaying the deck selection screen 60 and a used-deck operation portion 60b for displaying the used deck screen 62 are displayed on the deck selection screen 60.

In this embodiment, it is possible to execute the battle game in the boss challenge by using a saved “deck” (usable game medium) of the player. Accordingly, it is possible to give the player a play motivation to organize a more powerful “deck” by repeatedly executing the normal battle in order to achieve advantageous proceeding of the boss challenge.

In addition, in this embodiment, the saved “deck” of the player can be used only once. Consequently, the “deck” that has been used once is designated as “used” and cannot be used again. Accordingly, it is possible to give the player a play motivation to organize a plurality of more powerful “decks” by repeatedly executing the normal battle in order to achieve advantageous proceeding of the boss challenge.

As shown in FIG. 12A, the deck selection screen 60 displays, of the “decks” of the player stored on the basis of the execution of the normal battle, described above, information corresponding to the “decks” that have not been used in the boss challenge, in other words, the “decks” that are unused in the boss challenge.

Specifically, as shown in FIG. 12A, the deck selection screen 60 displays the ranking of the player when the “decks” were stored, the battle strengths based on the units incorporated into the “decks”, the specifics of the synergies based on the units incorporated into the “decks”, the combination of the units incorporated into the “decks”, and the time at which the “decks” were created. In addition, a selection operation portion 60c corresponding to each of the “decks” is displayed in a selectable manner.

In addition, as shown in FIG. 12B, the used deck screen 62 displays the ranking of the player when the “deck” was stored, the battle strength based on the units incorporated into the “deck”, the specifics of the synergies based on the units incorporated into the “deck”, the combination of the units incorporated into the “deck”, and the time at which the “deck” was created. In addition, the selection operation portion 60c corresponding to each of the “decks” is displayed in an unselectable manner.

Note that the used deck screen 62 may additionally display the results (damage amounts inflicted on the battle opponent NPC) of the boss challenge executed by employing each of the displayed “decks”. In addition, regarding the number of the used “decks” to be displayed on the used deck screen 62, a maximum displayable number (for example, most-recent 30 decks) may be provided.

In addition, in the case in which there is no saved “deck” that is unused in the boss challenge, as shown in FIG. 12C, the deck selection screen 60 displays an image indicating “there is no usable deck” and “let's complete a deck in normal battle!” and the normal-battle operation portion 30a.

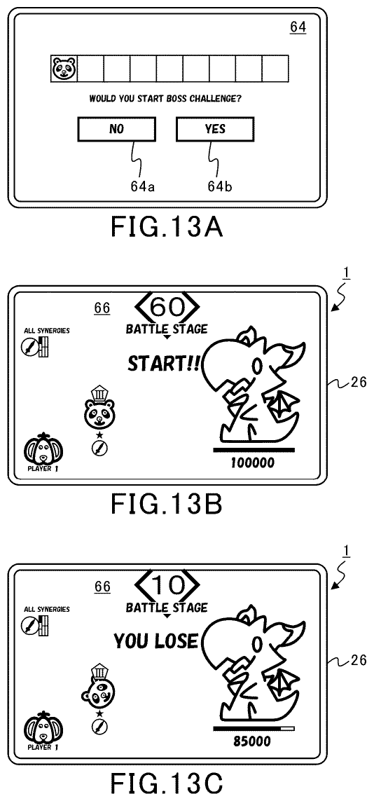

FIG. 13A is a diagram for explaining a use confirmation screen 64. When the selection operation portion 60c is operated (tapped) on the deck selection screen 60 in FIG. 12A, the use confirmation screen 64 shown in FIG. 13A is displayed on the display 26 (B2 in FIG. 4). As shown in FIG. 13A, on the use confirmation screen 64, the units constituting the “deck” corresponding to the selection operation portion 60c operated on the deck selection screen 60 are displayed.

In addition, as shown in FIG. 13A, on the use confirmation screen 64, an image indicating “would you start boss challenge?” is displayed and a NO operation portion 64a and a YES operation portion 64b are displayed on the display 26.

When the NO operation portion 64a is operated (tapped), the deck selection screen 60 is displayed on the display 26.

FIG. 13B is a diagram for explaining a battle screen 66 in the boss challenge. FIG. 13C is a diagram for explaining a result display in the boss challenge. When the YES operation portion 64b is operated (tapped), a battle game in the boss challenge starts, and the battle screen 66 is displayed on the display 26. When the battle screen 66 is displayed, the units incorporated into the “deck” selected by the player and the battle opponent NPC are displayed, and thus, the battle starts.

In the server 100, battle processing for determining win/lose in the battle game in the boss challenge is executed on the basis of the specifics of the “deck” of the player and the specifics of various kinds of parameters of the battle opponent NPC (B3 in FIG. 11). On the display 26, a battle image (battle movie) showing the state of the battle is displayed (played) on the basis of the result of the battle processing in the server 100.

The battle game in the boss challenge ends, when the HPs of all of the units incorporated into the “deck” of the player are entirely lost (0), the HP of the battle opponent NPC is entirely lost (0), or when a prescribed amount of time (in this case 60 s) has passed since the battle game has started.

When the battle game ends, as shown in FIG. 13C, the result display showing the result of the battle game is displayed on the battle screen 66, as shown in FIG. 13C. On the result display, win/lose of the player is notified.

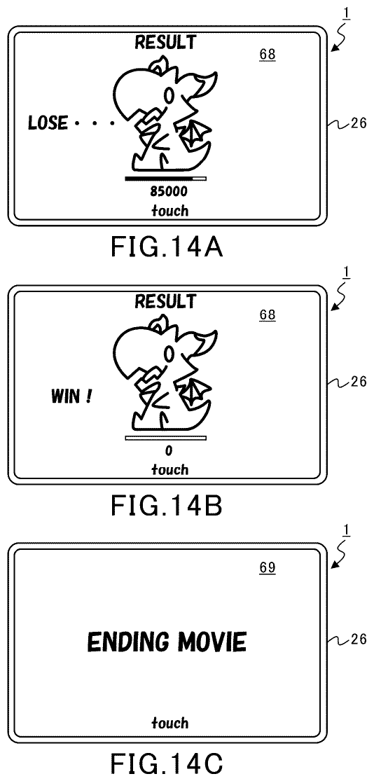

FIG. 14A is a first diagram for explaining a result screen 68 in the boss challenge. FIG. 14B is a second diagram for explaining the result screen 68 in the boss challenge. FIG. 14C is a diagram for explaining an ending screen 69 in the boss challenge. When the display of the battle screen 66 ends, the result screen 68 is displayed on the display 26 (B4 in FIG. 11).

FIG. 14A shows the result screen 68 displayed in the case in which the player has lost against the battle opponent NPC. FIG. 14B shows the result screen 68 displayed in the case in which the player has won against the battle opponent NPC. Note that, in this embodiment, as a result of the battle game in the boss challenge, the result screen 68 shown in FIG. 14B is displayed in the case in which the battle opponent NPC has lost all of the HP and the result screen 68 shown in FIG. 14A is displayed in the case in which the battle opponent NPC has not lost all of the HP.

In this embodiment, the HP of the battle opponent NPC at the end of the boss challenge is carried over to the HP of the battle opponent NPC in the next boss challenge. Accordingly, in the case in which the battle opponent NPC has not lost all of the HP, the player can cause the battle opponent NPC to lose all of the HP by repeatedly executing the boss challenge until the battle opponent NPC loses all of the HP. However, the boss challenge may be configured such that the HP of the battle opponent NPC at the end of the boss challenge is not carried over to the HP of the battle opponent NPC in the next boss challenge and the battle opponent NPC of the boss challenge entirely recovers the HP (initial state) every time. In other words, the boss challenge may be configured such that, in order to clear the boss challenge, the player needs to cause the battle opponent NPC to lose all of the HP in one round of the boss challenge. By employing such a configuration, it is possible to give the player a play motivation to organize a more powerful “deck”, which allows the player to cause the battle opponent NPC to lose all of the HP in one round of boss challenge, by repeatedly executing the normal battle. Furthermore, as indicated above, in this Example, the “deck” of the player saved for the boss challenge can be used only once, and the “deck” that has been used once is designated as “used” and cannot not be used again; therefore, every boss challenge gives a sense of tension to the player and it is possible to enhance the dramatic effect in the boss challenge.

When a tapping operation by the player is detected on the result screen 68 shown in FIG. 14A, prescribed ending processing (B5 in FIG. 11) is executed and the deck selection screen 60 is displayed on the display 26.

In addition, when a tapping operation by the player is detected on the result screen 68 shown in FIG. 14B, the ending screen 69 on which a prescribed ending movie shown in FIG. 14C is played is displayed on the display 26. In addition, when a tapping operation by the player is detected on the ending screen 69 shown in FIG. 14C, prescribed ending processing is executed and the deck selection screen 60 is displayed on the display 26.

Note that, the above-described boss challenge may also be configured so as to allow the power-up guild to be set. In this case, the power-up guild lottery may be performed when starting to execute the boss challenge. In addition, a guild that is set in advance may be set to the power-up guild. Alternatively, the power-up guild set in the normal battle may be set to be the power-up guild to be set in the boss challenge.

In addition, a plurality of battle opponent NPCs may be provided in the boss challenge. In this case, some of the NPCs may be configured such that, even if the physical strengths thereof are entirely lost, said NPCs are displayed again (restored) in the next boss challenge. In addition, some of the NPCs may be configured so as to possess an ability (skill) to cancel the increase in the values of the prescribed parameters and the enhancement of the ability of the prescribed skills due to the power-up guild.

Next, the functional configurations of the player terminal 1 and the server 100 for executing the above-described normal game and boss challenge will be described.

(Control processing in player terminal 1 and server 100)

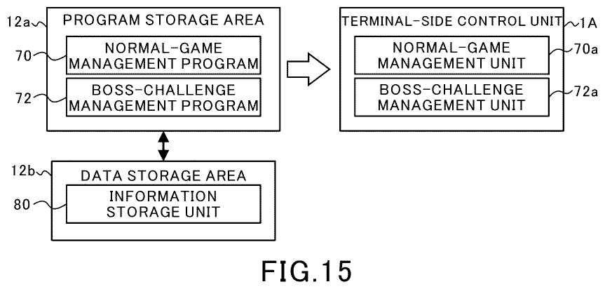

FIG. 15 is a diagram for explaining the configuration of the memory 12 in the player terminal 1 and the function thereof as a computer.

A program storage area 12a stores a normal-game management program 70 and a boss-challenge management program 72. Note that each of the programs mentioned above are examples and the program storage area 12a is provided with numerous other programs.

A data storage area 12b is provided with an information storage unit 80 that stores various kinds of information for the normal game and the boss challenge.

The CPU 10 runs the respective programs stored in the program storage area 12a and updates the data in the respective storage units in the data storage area 12b. Also, the CPU 10 causes the player terminal 1 (computer) to function as a terminal-side control unit 1A by running the respective programs stored in the program storage area 12a. The terminal-side control unit 1A contains a normal-game management unit 70a and a boss-challenge management unit 72a.

Specifically, the CPU 10 runs the normal-game management program 70 and causes a computer to function as the normal-game management unit 70a. Similarly, the CPU 10 runs the boss-challenge management program 72 and causes the computer to function as the boss-challenge management unit 72a.

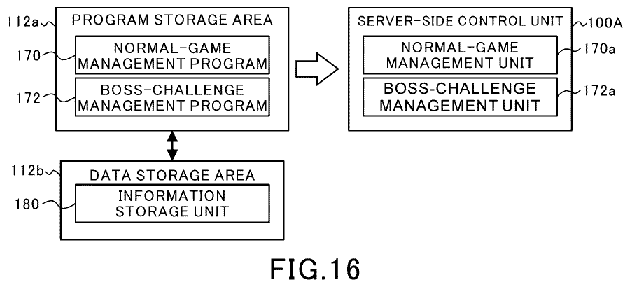

FIG. 16 is a diagram for explaining the configuration of the memory 112 in the server 100 and the function thereof as a computer. A program storage area 112a stores a normal-game management program 170 and a boss-challenge management program 172. Note that each of the programs mentioned above are examples and the program storage area 112a is provided with numerous other programs.

A data storage area 112b is provided with an information storage unit 180 that stores various kinds of information for the normal game and the boss challenge. The CPU 110 runs the respective programs stored in the program storage area 112a and updates the data in the respective storage units in the data storage area 112b. Also, the CPU 110 causes the sever 100 (computer) to function as a server-side control unit 100A by running the respective programs stored in the program storage area 112a. The server-side control unit 100A contains a normal-game management unit 170a and a boss-challenge management unit 172a.

Specifically, the CPU 110 runs the normal-game management program 170 and causes a computer to function as the normal-game management unit 170a. Similarly, the CPU 110 runs the boss-challenge management program 172 and causes the computer to function as the boss-challenge management unit 172a. In the following, some of processing executed by the terminal-side control unit 1A and the server-side control unit 100A will be described.

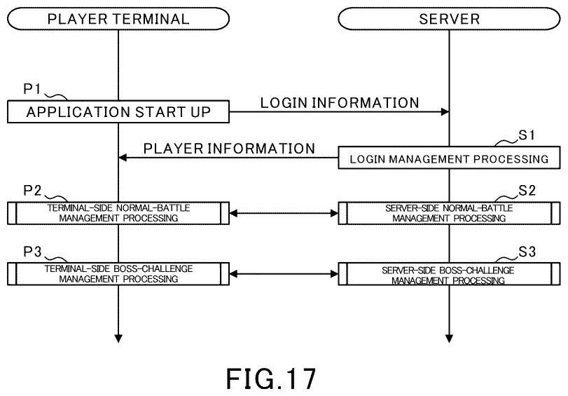

FIG. 17 is a sequence diagram for the player terminal 1 and the server 100. Note that, in the following description, the processing in the player terminal 1 will be indicated as Pn (n is an arbitrary integer). In addition, the processing in the server 100 will be indicated as Sn (n is an arbitrary integer).

When the player performs a login operation, such as starting up a game application, in the player terminal 1, the terminal-side control unit 1A transmits login information to the server 100.

In the server 100, when the login information is received, the server-side control unit 100A performs login management processing for causing the player terminal 1 to receive (acquire) player information and game information saved in the server 100.

In the player terminal 1, when the player information is received (acquired) from the server 100, the terminal-side control unit 1A stores the received player information and game information in the information storage unit 180.

In addition, in the case in which the normal battle is executed in the player terminal 1, the normal-game management unit 70a of the player terminal 1 executes terminal-side normal-battle management processing (P2). During this terminal-side normal-battle management processing (P2), communication processing is performed between the player terminal 1 and the server 100. In the server 100, the normal-game management unit 170a of the server 100 executes server-side normal-battle management processing (S2) on the basis of the information received from the player terminal 1.

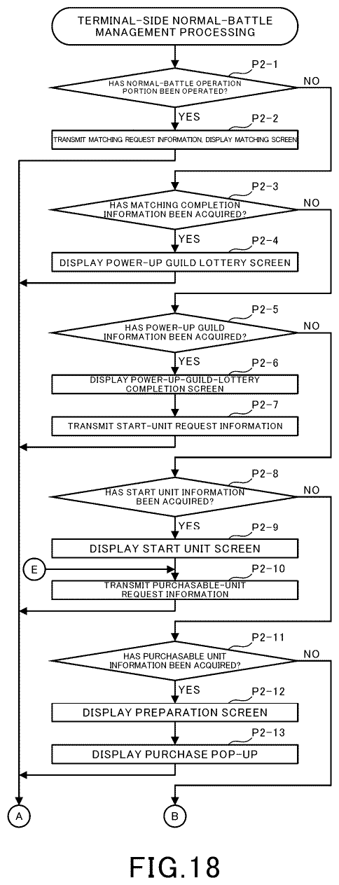

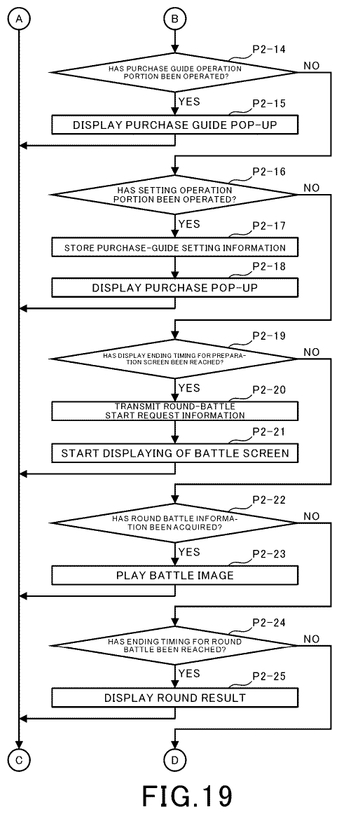

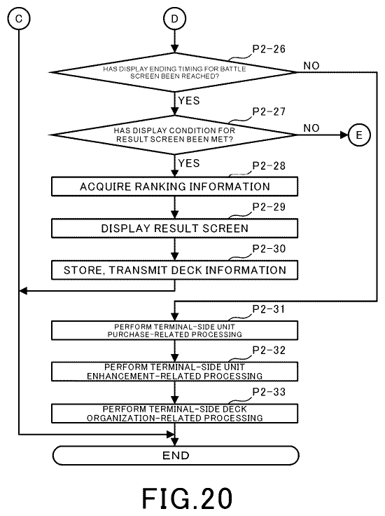

FIG. 18 is a first flowchart for explaining an example of the terminal-side normal-battle management processing in the player terminal 1. FIG. 19 is a second flowchart for explaining the example of the terminal-side normal-battle management processing in the player terminal 1. FIG. 20 is a third flowchart for explaining the example of the terminal-side normal-battle management processing in the player terminal 1. The normal-game management unit 70a of the player terminal 1 determines whether or not the normal-battle operation portion 30a has been operated (P2-1).

As a result, in the case in which it is determined that the normal-battle operation portion 30a has been operated (“YES” in P2-1), the normal-game management unit 70a of the player terminal 1 transmits matching request information to the server 100, causes the matching screen 32 to be displayed on the display 26 (P2-2), and ends said terminal-side normal-battle management processing. The matching request information contains the player information of the player.

In addition, in the case in which the normal-battle operation portion 30a is not operated (“NO” in P2-1), the normal-game management unit 70a of the player terminal 1 determines whether or not matching completion information has been acquired from the server 100 (P2-3). The matching completion information contains the player information of each of the participating players in the normal battle.

In the case in which it is determined that the matching completion information has been acquired from the server 100 (“YES” in P2-3), the normal-game management unit 70a of the player terminal 1 causes the power-up guild lottery screen 34a to be displayed on the display 26 (P2-4). In this embodiment, when the power-up guild lottery screen 34a is displayed on the display 26 over a prescribed amount of time (for example, 3 s) set in advance, the normal-game management unit 70a of the player terminal 1 ends said terminal-side normal-battle management processing.

In addition, in the case in which the matching completion information is not acquired from the server 100 (“NO” in P2-3), the normal-game management unit 70a of the player terminal 1 determines whether or not power-up guild information has been acquired from the server 100 (P2-5). The power-up guild information contains information regarding the type of the power-up guild determined in the server 100.

In the case in which it is determined that the power-up guild information has been acquired from the server 100 (“YES” in P2-5), the normal-game management unit 70a of the player terminal 1 causes the power-up-guild-lottery completion screen 34b to be displayed on the display 26 (P2-6). In this embodiment, when the power-up-guild-lottery completion screen 34b is displayed on the display 26 over a prescribed amount of time (for example, 5 s) set in advance, the normal-game management unit 70a of the player terminal 1 advances the processing to a step P2-7, described later.

The normal-game management unit 70a of the player terminal 1 transmits start-unit request information for requesting the start unit lottery result to the server 100 (P2-7) and ends said terminal-side normal-battle management processing.

In addition, in the case in which it is determined that the power-up guild information has not been acquired from the server 100 (“NO” in P2-5), the normal-game management unit 70a of the player terminal 1 determines whether or not start unit information has been acquired from the server 100 (P2-8). Note that the start unit information contains information regarding the specifics of the start units to be given to the player, determined in the server 100.

In the case in which it is determined that the start unit information has been acquired from the server 100 (“YES” in P2-8), the normal-game management unit 70a of the player terminal 1 causes the start unit screen 36 to be displayed on the display 26 on the basis of the acquired start unit information (P2-9). In this embodiment, when the start unit screen 36 is displayed on the display 26 over a prescribed amount of time (for example, 5 s) set in advance, the normal-game management unit 70a of the player terminal 1 advances the processing to a step P2-10, described later.

The normal-game management unit 70a of the player terminal 1 transmits purchasable-unit request information for requesting the purchasable unit lottery result to the server 100 (P2-10) and ends said terminal-side normal-battle management processing.

In addition, in the case in which it is determined that the start unit information has not been acquired from the server 100 (“NO” in P2-8), the normal-game management unit 70a of the player terminal 1 determines whether or not purchasable unit information has been acquired from the server 100 (P2-11). Note that the purchasable unit information contains information regarding the specifics of the purchasable units determined in the server 100.

In the case in which it is determined that the purchasable unit information has been acquired from the server 100 (“YES” in P2-11), the normal-game management unit 70a of the player terminal 1 causes the preparation screen 38 to be displayed on the display 26 (P2-12). In addition, the normal-game management unit 70a of the player terminal 1 causes the purchase pop-up 40 to be displayed on the display 26, on the basis of the acquired purchasable unit information (P2-13) and ends said terminal-side normal-battle management processing.

In the case in which it is determined that the purchasable unit information has not been acquired from the server 100 (“NO” in P2-11), the normal-game management unit 70a of the player terminal 1 determines whether or not the purchase guide operation portion 40a has been operated (P2-14 in FIG. 19).

As a result, in the case in which it is determined that the purchase guide operation portion 40a has been operated (“YES” in P2-14), the normal-game management unit 70a of the player terminal 1 causes the purchase guide pop-up 42 to be displayed on the display 26 (P2-15) and ends said terminal-side normal-battle management processing.

In addition, in the case in which it is determined that the purchase guide operation portion 40a has not been operated (“NO” in P2-14), the normal-game management unit 70a of the player terminal 1 determines whether or not the setting operation portion 42a has been operated (P2-16).

In the case in which it is determined that the setting operation portion 42a has been operated (“YES” in P2-16), the normal-game management unit 70a of the player terminal 1 stores the specifics of the “deck” corresponding to the operated setting operation portion 42a in the information storage unit 80 as purchase-guide setting information (P2-17). In addition, the normal-game management unit 70a of the player terminal 1 causes the purchase pop-up 40 to be displayed on the display 26 on the basis of the purchase-guide setting information stored in the information storage unit 80 and the purchase guide information (P2-18) and ends said terminal-side normal-battle management processing.

In addition, in the case in which it is determined that the setting operation portion 42a has not been operated (“NO” in P2-16), the normal-game management unit 70a of the player terminal 1 determines whether or not a display ending timing for the preparation screen 38 has been reached (P2-19). Specifically, in this embodiment, in the case in which the value of the timer displayed in the center of the upper section of the preparation screen 38 has reached “0” and in the case in which the player and the opponent players both operate (tap) the preparation complete operation portion 38d before the value of the timer displayed in the center of the upper section of the preparation screen 38 reaches “0”, it is determined that the display ending timing for the preparation screen 38 has been reached.

As a result, in the case in which it is determined that the display ending timing for the preparation screen 38 has been reached (“YES” in P2-19), the normal-game management unit 70a of the player terminal 1 transmits round-battle start request information for requesting to start the round battle to the server 100 (P2-20). In addition, the normal-game management unit 70a of the player terminal 1 causes the battle screen 44 to be displayed on the display 26 (P2-21) and ends said terminal-side normal-battle management processing.

In addition, in the case in which it is determined that the display ending timing for the preparation screen 38 has not been reached (“NO” in P2-19), the normal-game management unit 70a of the player terminal 1 determines whether or not round battle information has been acquired from the server 100 (P2-22).

As a result, in the case in which it is determined that the round battle information has been acquired from the server 100 (“YES” in P2-22), the normal-game management unit 70a of the player terminal 1 causes the display (playing) of the battle image in the round battle to be started on the basis of the acquired round battle information (P2-23) and ends said terminal-side normal-battle management processing. Note that the round battle information contains information about the opponent players in the round battle, win/lose in the round battle, and various kinds of information for displaying the battle image in the round battle.

In the case in which it is determined that the round battle information has not been acquired from the server 100 (“NO” in P2-22), the normal-game management unit 70a of the player terminal 1 determines whether or not a round-battle ending timing has been reached (P2-24). Note that the round-battle ending timing refers to a timing at which the HPs of all of the units incorporated into the “deck” of the player are entirely lost (0), a timing at which the HPs of all of the units incorporated into the “decks” of the opponent players are entirely lost (0), or a timing at which a prescribed amount of time (in this case, 60 s) has passed since the battle game has started.

In the case in which it is determined that the round-battle ending timing has been reached (“YES” in P2-24), the normal-game management unit 70a of the player terminal 1 causes the round result shown in FIG. 10A to be displayed on the display 26 on the basis of the acquired round battle information (P2-25) and ends said terminal-side normal-battle management processing.

In addition, in the case in which it is determined that the round-battle ending timing has not been reached (“NO” in P2-24), the normal-game management unit 70a of the player terminal 1 determines whether or not a display ending timing for the battle screen 44 has been reached (P2-26 in FIG. 20).

In the case in which it is determined that the display ending timing for the battle screen 44 has been reached (“YES” in P2-26), the normal-game management unit 70a of the player terminal 1 determines whether or not a display condition for the result screen 46 has been met (P2-27). In this embodiment, the case in which the display condition for the result screen 46 is met is defined as the case in which the player has lost the battle game and the player has entirely lost the physical strength or the case in which the player achieves the first place (victory) in the ranking.

In the case in which it is determined that the display condition for the result screen 46 has been met (“YES” in P2-27), the normal-game management unit 70a of the player terminal 1 acquires ranking information from the server 100 (P2-28). In addition, the normal-game management unit 70a of the player terminal 1 causes the result screen 46 to be displayed on the display 26 on the basis of the acquired ranking information (P2-29). In addition, the normal-game management unit 70a of the player terminal 1 stores deck information, which indicates the “deck” of the player organized in the battle game in the round battle immediately before the result screen 46 is displayed, in the information storage unit 80 of the player terminal 1. In addition, here, the normal-game management unit 70a transmits the deck information to the server 100 (P2-30) and ends said terminal-side normal-battle management processing.

Note that, as indicated above, in this embodiment, the number of the owned units that can be incorporated into a deck is set to be equal to the player level. However, while the preparation screen 38 is displayed, it may be temporarily allowed to incorporate the owned units into a deck in a greater number than the number of owned units that can be incorporated into the “deck”. In this case, the display of the preparation screen 38 ends and, at the timing at which the screen transitions to the battle screen 44, the organization of the “deck” is forcedly changed so as to conform to the number of the owned units that can be incorporated into the “deck”.

For example, as indicated above, while the preparation screen 38 is displayed, when the owned units are temporarily incorporated into the “deck” in a greater number than the number of owned units that can be incorporated into the “deck”, it is conceivable that an irregular event, such as the opponent players logging out, occurs and the condition for ending the normal battle is met. In this case, at the timing at which said condition for ending the normal battle is met, the organization of the “deck” may be forcedly changed so as to conform to the number of the owned units that can be incorporated into the “deck”, and the normal-game management unit 70a may transmit the deck information containing said forcedly changed specifics to the server 100.

In addition, in the case in which it is determined that the display condition for the result screen 46 has not been met (“NO” in P2-27), the normal-game management unit 70a of the player terminal 1 advances the processing to step P2-10, mentioned above.

In addition, in the case in which it is determined that the ending timing for the battle screen 44 has not been reached (“NO” in P2-26), the normal-game management unit 70a of the player terminal 1 executes terminal-side unit purchase-related processing (P2-31). In the terminal-side unit purchase-related processing, processing related to purchasing (adjusting) of the units displayed on the purchase pop-up 40 based on the operation by the player is executed.

In addition, the normal-game management unit 70a of the player terminal 1 executes terminal-side unit enhancement-related processing (P2-32). In the terminal-side unit enhancement-related processing, processing related to the evolution (adjustment) of the owned units based on the operation by the player is executed.

In addition, the normal-game management unit 70a of the player terminal 1 executes terminal-side deck organization-related processing (P2-33). In the terminal-side deck organization-related processing, processing related to organization (adjustment) of the “deck” based on the operation by the player is executed.

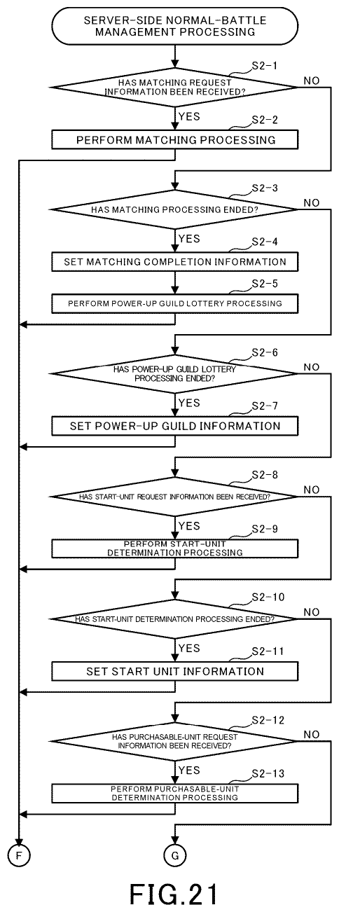

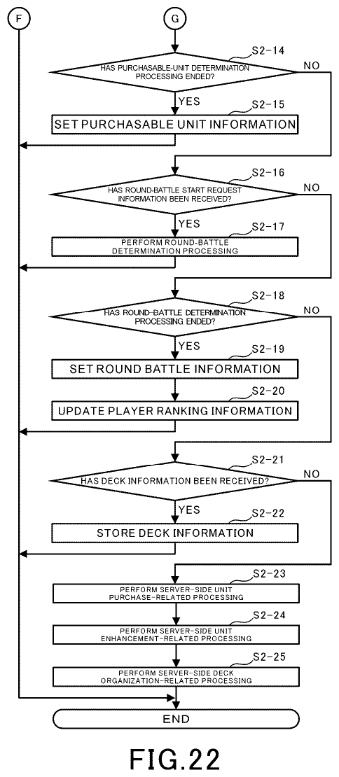

FIG. 21 is a first flowchart for explaining an example of server-side normal-battle management processing in the server 100. FIG. 22 is a second flowchart for explaining the example of the server-side normal-battle management processing in the server 100. The normal-game management unit 170a of the server 100 determines whether or not the matching request information has been received from the player terminal 1 (S2-1).

As a result, in the case in which it is determined that the matching request information has been received from the player terminal 1 (“YES” in S2-1), the normal-game management unit 170a of the server 100 executes the matching processing and ends said server-side normal-battle management processing.

In addition, in the case in which it is determined that the matching request information has not been received from the player terminal 1 (“NO” in S2-1), the normal-game management unit 170a of the server 100 determines whether or not the matching processing has ended (S2-3).

In the case in which it is determined that the matching processing has ended (“YES” in S2-3), the normal-game management unit 170a of the server 100 sets the matching completion information so that the player terminal 1 can acquire said information (S2-4). In addition, the normal-game management unit 170a of the server 100 executes power-up guild lottery processing (S2-5) and ends said server-side normal-battle management processing.

In addition, the normal-game management unit 170a of the server 100 determines whether or not the power-up guild lottery processing has ended (S2-6). As a result, in the case in which it is determined that the power-up guild lottery processing has ended (“YES” in S2-6), the normal-game management unit 170a of the server 100 sets the power-up guild information so that the player terminal 1 can acquire said information (S2-7) and ends said server-side normal-battle management processing.

In addition, the normal-game management unit 170a of the server 100 determines whether or not the start-unit request information has been received from the player terminal 1 (S2-8). As a result, in the case in which it is determined that the start-unit request information has been received from the player terminal 1 (“YES” in S2-8), the normal-game management unit 170a of the server 100 executes start-unit determination processing (S2-9) and ends said server-side normal-battle management processing.

In addition, the normal-game management unit 170a of the server 100 determines whether or not the start-unit determination processing has ended (S2-10). As a result, in the case in which it is determined that the start-unit determination processing has ended (“YES” in S2-10), the normal-game management unit 170a of the server 100 sets the start unit information so that the player terminal 1 can acquire said information (S2-11) and ends said server-side normal-battle management processing.

In addition, the normal-game management unit 170a of the server 100 determines whether or not the purchasable-unit request information has been received from the player terminal 1 (S2-12). As a result, in the case in which it is determined that the purchasable-unit request information has been received from the player terminal 1 (“YES” in S2-12), the normal-game management unit 170a of the server 100 executes purchasable-unit determination processing (S2-13) and ends said server-side normal-battle management processing. In addition, the normal-game management unit 170a of the server 100 determines whether or not the purchasable-unit determination processing has ended (S2-14 in FIG. 22). As a result, in the case in which it is determined that the purchasable-unit determination processing has ended (“YES” in S2-14), the normal-game management unit 170a of the server 100 sets the purchasable unit information so that the player terminal 1 can acquire said information (S2-15) and ends said server-side normal-battle management processing.

In addition, the normal-game management unit 170a of the server 100 determines whether or not the round-battle start request information has been received from the player terminal 1 (S2-16). As a result, in the case in which it is determined that the round-battle start request information is received from the player terminal 1 (“YES” in S2-16), the normal-game management unit 170a of the server 100 executes round-battle determination processing for deriving round-battle determination information (S2-17) and ends said server-side normal-battle management processing.

In addition, the normal-game management unit 170a of the server 100 determines whether or not the round-battle determination processing has ended (S2-18). As a result, in the case in which it is determined that the round-battle determination processing has ended (“YES” in S2-18), the normal-game management unit 170a of the server 100 sets the round-battle determination information so that the player terminal 1 can acquire said information (S2-19). In addition, the normal-game management unit 170a of the server 100 updates the ranking information of the player on the basis of the round-battle determination information and ends said server-side normal-battle management processing.

In addition, the normal-game management unit 170a of the server 100 determines whether or not the deck information has been received from the player terminal 1 (S2-21). As a result, in the case in which it is determined that the deck information has been received from the player terminal 1 (“YES” in S2-21), the normal-game management unit 170a of the server 100 stores the received deck information in the information storage unit 180 and ends said server-side normal-battle management processing.

In addition, the normal-game management unit 170a of the server 100 executes server-side unit purchase-related processing (S2-23). In the server-side unit purchase-related processing, processing related to purchasing (adjusting) of the units displayed in the purchase pop-up 40 based on the operation by the player is executed.

In addition, the normal-game management unit 170a of the server 100 executes server-side unit enhancement-related processing (S2-24). In the server-side unit enhancement-related processing, processing related to the evolution (adjustment) of the owned units based on the operation by the player is executed.

In addition, the normal-game management unit 170a of the server 100 executes server-side deck organization-related processing (S2-24). In the server-side deck organization-related processing, processing related to organization (adjustment) of the “deck” based on the operation by the player is executed.

Returning to FIG. 17, in the case in which the boss challenge is executed in the player terminal 1, the boss-challenge management unit 72a of the player terminal 1 executes terminal-side boss-challenge management processing (P3). During the terminal-side boss-challenge management processing (P3), communication processing is performed between the player terminal 1 and the server 100. In the server 100, the boss-challenge management unit 172a of the server 100 executes server-side boss-challenge management processing (S3) on the basis of the information received from the player terminal 1.

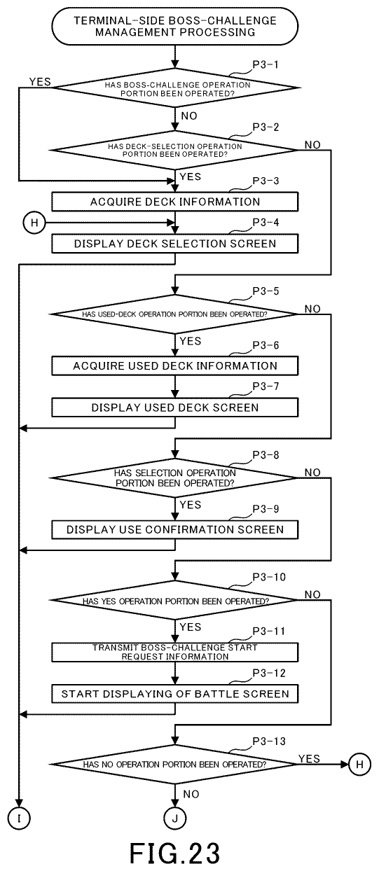

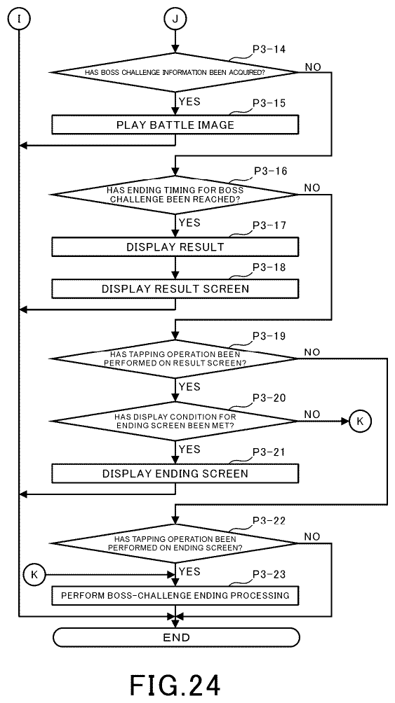

FIG. 23 is a first flowchart for explaining an example of the terminal-side boss-challenge management processing in the player terminal 1. FIG. 24 is a second flowchart for explaining the example of the terminal-side boss-challenge management processing in the player terminal 1. The boss-challenge management unit 72a of the player terminal 1 determines whether or not the boss-challenge operation portion 30b has been operated (P3-1).

As a result, in the case in which it is determined that the boss-challenge operation portion 30b has not been operated (“NO” in P3-1), the boss-challenge management unit 72a of the player terminal 1 determines whether or not the deck-selection operation portion 60c has been operated (P3-2).

In the case in which it is determined that the boss-challenge operation portion 30b has been operated (“YES” in P3-1) or in the case in which it is determined that the deck-selection operation portion 60c has been operated (“YES” in P3-2), the boss-challenge management unit 72a of the player terminal 1 acquires the deck information from the server 100 (P3-3). In addition, the boss-challenge management unit 72a of the player terminal 1 causes the deck selection screen 60 to be displayed on the display 26 on the basis of the acquired deck information (P3-4) and ends said terminal-side boss-challenge management processing.

In addition, in the case in which it is determined that the deck-selection operation portion 60c has not been operated (“NO” in P3-2), the boss-challenge management unit 72a of the player terminal 1 determines whether or not the used-deck operation portion 60b has been operated (P3-5).

As a result, in the case in which it is determined that the used-deck operation portion 60b has been operated (“YES” in P3-5), the boss-challenge management unit 72a of the player terminal 1 acquires used deck information from the server 100 (P3-6). The used deck information contains information related to the “decks” of the player that have been used in the boss challenge. In addition, the boss-challenge management unit 72a of the player terminal 1 causes the used deck screen 62 to be displayed on the display 26 on the basis of the acquired used deck information (P3-7) and ends said terminal-side boss-challenge management processing.

In addition, in the case in which it is determined that the used-deck operation portion 60b has not been operated (“NO” in P3-5), the boss-challenge management unit 72a of the player terminal 1 determines whether or not the selection operation portion 60c has been operated (P3-8).

As a result, in the case in which it is determined that the selection operation portion 60c has been operated (“YES” in P3-8), the boss-challenge management unit 72a of the player terminal 1 causes the use confirmation screen 64 to be displayed on the display 26 (P3-9) and ends said terminal-side boss-challenge management processing.

In addition, in the case in which it is determined that the selection operation portion 60c has not been operated (“NO” in P3-8), the boss-challenge management unit 72a of the player terminal 1 determines whether or not the YES operation portion 64b has been operated (P3-10).

As a result, in the case in which it is determined that the YES operation portion 64b has been operated (“YES” in P3-10), the boss-challenge management unit 72a of the player terminal 1 transmits boss-challenge start request information for requesting to start the boss challenge to the server 100. The boss-challenge start request information contains information related to the “deck” of the player selected in the selection operation portion 60c. In addition, the boss-challenge management unit 72a of the player terminal 1 starts the display of the battle screen 66 on the display 26 (P3-12) and ends said terminal-side boss-challenge management processing.

In addition, in the case in which it is determined that the YES operation portion 64b has not been operated (“NO” in P3-10), the boss-challenge management unit 72a of the player terminal 1 determines whether or not the NO operation portion 64a has been operated (P3-13).

As a result, in the case in which it is determined that the NO operation portion 64a has been operated (“YES” in P3-13), the processing advances to step P3-4, mentioned above.

In addition, in the case in which it is determined that the NO operation portion 64a has not been operated (“NO” in P3-13), the boss-challenge management unit 72a of the player terminal 1 determines whether or not boss challenge information has been acquired from the server 100 (P3-14 in FIG. 24). Note that the boss challenge information contains win/loss of the player in the boss challenge, information about the HP of the battle opponent NPC after the execution of the boss challenge, and various kinds of information for displaying the battle image in the boss challenge.

In the case in which it is determined that the boss challenge information has been acquired from the server 100 (“YES” in P3-14), the boss-challenge management unit 72a of the player terminal 1 causes the display (playing) of the battle image in the boss challenge to be started on the basis of the acquired boss challenge information (P3-15) and ends said terminal-side boss-challenge management processing.

In addition, in the case in which it is determined that the boss challenge information has not been acquired from the server 100 (“NO” in P3-14), the boss-challenge management unit 72a of the player terminal 1 determines whether or not an ending timing for the battle game in the boss challenge has been reached (P3-16). Note that the ending timing for the battle game of the boss challenge is the timing at which the HPs of all of the units incorporated into the “deck” of the player are entirely lost (0), the timing at which the HP of the battle opponent NPC is entirely lost (0), or the timing at which a prescribed amount of time (in this case, 60 s) has passed since the battle game has started.

As a result, in the case in which it is determined that the ending timing of the battle game in the boss challenge has been reached (“YES” in P3-16), the boss-challenge management unit 72a of the player terminal 1 causes the result display showing the results of the battle game to be displayed (P3-17), as shown in FIG. 13C. In addition, the boss-challenge management unit 72a of the player terminal 1 causes the result screen 68 to be displayed (P3-18) and ends said terminal-side boss-challenge management processing.

In addition, in the case in which it is determined that the ending timing for the battle game of the boss challenge has not been reached (“NO” in P3-16), the boss-challenge management unit 72a of the player terminal 1 determines whether or not a tapping operation has been detected on the result screen 68 (P3-19).

As a result, in the case in which it is determined that a tapping operation has been detected on the result screen 68 (“YES” in S3-19), the boss-challenge management unit 72a of the player terminal 1 determines whether or not a display condition for the ending screen 69 has been met (P3-20). Note that the case in which the display condition for the ending screen 69 has been met is the case in which a tapping operation by the player is detected on the result screen 46 (FIG. 14B) displayed in the case in which the player has won against the battle opponent NPC.

As a result, in the case in which it is determined that the display condition for the ending screen 69 has been met (“YES” in P3-20), the boss-challenge management unit 72a of the player terminal 1 causes the ending screen 69 to be displayed on the display 26 (P3-21) and ends said terminal-side boss-challenge management processing.

In the case in which it is determined that a tapping operation has not been detected on the result screen 68 (“NO” in S3-19), the boss-challenge management unit 72a of the player terminal 1 determines whether or not a tapping operation by the player has been detected on the ending screen 69 (P3-22).

As a result, in the case in which it is determined that a tapping operation by the player has been detected on the ending screen 69 (“YES” in P3-22) and in the case in which it is determined that the display condition for the ending screen 69 has not been met (“NO” in P3-20), the boss-challenge management unit 72a of the player terminal 1 executes the prescribed ending processing (P3-23) and causes the deck selection screen 60 to be displayed on the display 26.

In addition, in the case in which it is determined that a tapping operation by the player has not been detected on the ending screen 69 (“NO” in P3-22), the boss-challenge management unit 72a of the player terminal 1 ends said terminal-side boss-challenge management processing.

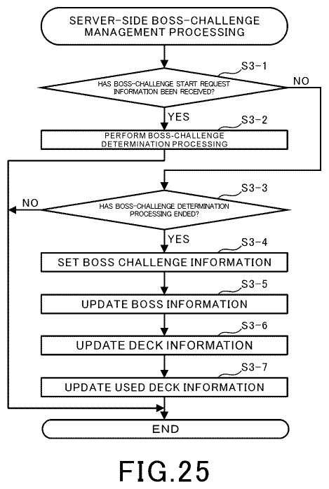

FIG. 25 is a flowchart for explaining an example of server-side boss-challenge management processing in the server 100. The boss-challenge management unit 172a of the server 100 determines whether or not the boss-challenge start request information has been received from the player terminal 1 (S3-1).

As a result, in the case in which it is determined that the boss-challenge start request information has been received from the player terminal 1 (“YES” in S3-1), the boss-challenge management unit 172a of the server 100 executes boss-challenge determination processing for deriving boss challenge information (S3-2) and ends said server-side boss-challenge management processing.

In addition, in the case in which it is determined that the boss-challenge start request information has not been received from the player terminal 1 (“NO” in S3-1), the boss-challenge management unit 172a of the server 100 determines whether or not the boss-challenge determination processing has ended (S3-3).

As a result, in the case in which it is determined that the boss-challenge determination processing has ended (“YES” in S3-3), the boss-challenge management unit 172a of the server 100 sets the boss challenge information so that the player terminal 1 can acquire said information (S3-4).

In addition, the boss-challenge management unit 172a of the server 100 updates the boss information on the basis of the derived boss challenge information and updates the HP of the battle opponent NPC of the boss challenge (S3-5). The boss information contains information related to the HP of the battle opponent NPC in the boss challenge.

In addition, the boss-challenge management unit 172a of the server 100 updates the deck information and deletes the “deck” used in the boss challenge from the deck information (S3-6).

In addition, the boss-challenge management unit 172a of the server 100 updates the used deck information and designates the “deck” used in the boss challenge as “used” (S3-7).

In addition, in the case in which it is determined that the boss-challenge determination processing has not ended (“NO” in S3-3), the boss-challenge management unit 172a of the server 100 ends said server-side boss-challenge management processing.

As above, an aspect of this embodiment has been described with reference to the attached drawings; however, it is needless to say that the present invention is not limited to the above-described embodiment. It is obvious that a person skilled in the art could conceive of various types of modifications and corrected examples within the scope of the claims, and it is understood that the technical scope of the present invention also naturally encompasses such forms. The game properties and the processing in the player terminal 1 and the server 100 described in the above-described embodiment are merely examples. In any case, the information processing program may employ any configuration so long as said program causes a computer (one of or both of the player terminal 1 and the server 100 in this embodiment) to execute the processing below.

(Processing to be executed by computer)

Processing (examples thereof are P2 and S2 in this embodiment) for executing a first game (an example thereof is the normal battle in this embodiment) including a first battle game (an example thereof is the round battle in the normal battle in this embodiment) against other players by using a game medium (an example thereof is the owned unit in this embodiment).

Processing (examples thereof are P2-32 and S2-24 in this embodiment) for making the adjustment of the game medium executable in the first game.

Processing (examples thereof are P2-30 and S2-22 in this embodiment) for saving, in the case in which an ending condition for the first game is met, the game medium used in the first game as a usable game medium (an example thereof is the “deck” in this embodiment).

Processing (examples thereof are P3 and S3 in this embodiment) for executing a second game (an example thereof is the boss challenge in this embodiment) including a second battle game (an example thereof is the battle game in the boss challenge in this embodiment) against a computer-controlled battle opponent by using the usable game medium.

In the above-described embodiment, the case in which the unit is employed as an example of the game medium has been described; however, it is not limited thereto. Specifically, any game medium may be employed so long as the game medium can be used when executing the first game including the first battle game against the other players, and the specific details of the game medium are not particularly limited.

In addition, processing for determining the ranking of the player on the basis of the result of the first battle game may additionally executed (an example thereof is S2-20 in this embodiment). However, for example, the player may be evaluated (for example, an evaluation based on the score, wherein the full score is 100 points) on the basis of the result of the first battle game instead of determining the ranking of the player on the basis of the result of the first battle game.

In addition, the processing for making the game medium adjustment executable may be executable between the start and the end of the first battle game (an example thereof is the round battle of the normal battle in this embodiment). However, the processing for making the game medium adjustment executable may be executable during a period in which the first battle game is not being executed.

In addition, the usable game medium may be usable only once. However, the usable game medium may be usable for multiple times.

In addition, the processing for making the game medium adjustment executable may allow, on the basis of an operation by the player, at least one of changing the game medium to be used (an example thereof is the changing of the organization of the “deck” in this embodiment) and changing of the game medium parameter (an example thereof is the evolution of an owned unit in this embodiment). In addition, as the game medium adjustment, changing of the game medium parameter by giving a prescribed item (weapon item) to the game medium may be made executable.

Note that the information processing program for executing the processing in the above-described embodiment and various kinds of modifications thereof may be stored in a computer-readable, non-transitory storage medium and may be provided in the form of the storage medium. Furthermore, a game terminal device containing this storage device may be provided. In addition, the above-described embodiment and various kinds of modifications thereof may be configured as an information processing method for realizing the respective functions and the steps shown in the flowcharts.

What is claimed is:

1. A non-transitory computer readable medium storing a program causing a computer to execute:
processing for executing a first game including a first battle game against other players by using a game medium;
processing for making the adjustment of the game medium executable in the first game;
processing for saving, in the case in which an ending condition for the first game is met, the game medium used in the first game as a usable game medium; and
processing for executing a second game including a second battle game against a computer-controlled battle opponent by using the usable game medium.

2. The non-transitory computer readable medium according to claim 1, wherein the program further causes the computer to execute:
processing for determining ranking of a player on the basis of a result of the first battle game,
wherein the processing for making the adjustment of the game medium executable is executable between the start and the end of the first battle game.

3. The non-transitory computer readable medium according to claim 1, wherein the usable game medium is usable only once.

4. The non-transitory computer readable medium according to claim 1, wherein the processing for making the adjustment of the game medium executable makes it possible to perform at least one of changing the game medium to be used and changing a parameter of the game medium on the basis of an operation by the player.

5. An information processing method executed by at least one computer, wherein the at least one computer executes:
processing for executing a first game including a first battle game against other players by using a game medium;
processing for making the adjustment of the game medium executable in the first game;
processing for saving, in the case in which an ending condition for the first game is met, the game medium used in the first game as a usable game medium; and
processing for executing a second game including a second battle game against a computer-controlled battle opponent by using the usable game medium.

6. An information processing system including at least one computer, wherein the at least one computer executes:
processing for executing a first game including a first battle game against other players by using a game medium;
processing for making the adjustment of the game medium executable in the first game;
processing for saving, in the case in which an ending condition for the first game is met, the game medium used in the first game as a usable game medium; and
processing for executing a second game including a second battle game against a computer-controlled battle opponent by using the usable game medium.
